(19) United States
(12) Patent Application Publication
(10) Pub. No.: US 2009/0254453 A1
(43) Pub. Date: Oct. 8, 2009

(54) SYSTEM, METHOD, AND COMPUTER PROGRAM PRODUCT FOR CONVEYANCE OF GIFT AT SELECTED DATE AND TIME USING COMMUNICATION NETWORK

(76) Inventors: Dave T. Sanguinetti, La Jolla, CA (US); Thomas V. Sanguinetti, La Jolla, CA (US); Jeffrey S. Ploetner, La Jolla, CA (US)

Correspondence Address: Michael A. Rahman, 5664 Mallard Trace, Frisco, TX, 75034, US

(21) Appl. No.: 12/098,439

(22) Filed: Apr. 6, 2008

(51) Int. Cl. G06Q 30/00; G06Q 20/00

(52) U.S. Cl. 705/27; 705/39

(57) ABSTRACT

A method and system enables a conveying user to select one or more gift items and to deliver the selected gift items to a receiving user at the receiving user's location at a selected date and time. The method includes creating a database having identifying information and a conveyance permission profile for the receiving user. The method includes selecting, by the conveying user, one or more gift items from an online gift catalog, the selected gift items being qualified by the conveyance permission profile. The method includes selecting, by the conveying user, a delivery date and time of the selected gift items and purchasing the selected gift items. The method includes notifying a fulfillment system of the selection of the gift items and commencing delivery of the selected gift items in response to the notification, the selected gift items being delivered to the receiving user's location at the selected date and time.

### FIELD OF THE INVENTION

The invention relates to online methods and systems, and more particularly the invention relates to a system, method and computer program product for a conveyance of a gift at a selected date and time using a communication network.

### BACKGROUND OF THE INVENTION

Advancements in communication technology have enabled users to interact with one another online. The users may access the Internet using a personal computer or a mobile computing device, communicate with one another and conduct various transactions. The users may purchase gifts online and arrange for the delivery of the gifts to friends and family.

Some online retailers allow users to browse various gifts, select and purchase a gift, and send the gift to a friend or a family member. The online services, however, typically do not offer intelligent gift delivery options, such as calculated delivery dates and times. Furthermore, existing online services do not allow delivery location selection based on advanced factors, including conveying user delivery intentions, receiving user convenience, calculated receptivity factors, real-time user activity and predictive analysis, coordination with multiple gift deliveries, location-based services, and delivery feasibility. The online services also do not allow multiple conveying users to send several gifts, each being made available for intelligent delivery date and time selection at a pre-selected date and time. Also, the online services typically allow a user to send gifts to the receiving user's physical address, but do not allow delivery of gifts to a location at which the receiving user may be temporarily present. Since the online services do not allow delivery of the gifts at selected date and time at a venue or a location where the receiving user may be temporarily present, the delivery of the gifts often lack the element of complete surprise or excitement.

Accordingly, a need exists for a system and method that provides a solution to the foregoing problems.

### SUMMARY

In one embodiment, a method enables a conveying user to select one or more gift items and to deliver the selected gift items to a receiving user at the receiving user's location at a selected date and time. The conveying user and the receiving user are connected through a communication network. The method includes creating a database having identifying information and a conveyance permission profile for the receiving user. The conveyance permission profile qualifies the conveyance of any gift items to the receiving user. The method includes determining the location of the receiving user, the location being provided by a location determination system. The method includes optionally receiving, by the database, the location of the receiving user and optionally updating the database. The method includes selecting, by the conveying user, one or more gift items from an online gift catalog, the selected gift items being qualified by the conveyance permission profile. The method includes selecting, by the conveying user, a delivery date and time of the selected gift items and purchasing the selected gift items. The method includes notifying a fulfillment system of the selection of the gift items and commencing delivery of the selected gift items in response to the notification, the selected gift items being delivered to the receiving user's location at the selected date and time.

### BRIEF DESCRIPTION OF THE DRAWINGS

FIG. 1 is a flow diagram of a method for conveying a gift item to a receiving user in accordance with one embodiment.

FIG. 2 is a flow diagram of a method for creating a database in accordance with one embodiment.

FIG. 3 is a flow diagram of a method for conveying a gift item to a receiving user in accordance with another embodiment.

FIG. 4 is a system used to implement an example embodiment of the invention.

### DETAILED DESCRIPTION OF THE INVENTION

In one example implementation, an online conveyance system enables a conveying user to select and convey a gift to a receiving user at a selected location. The gift may be a product, a service, or an experience. In one example implementation, the system can auto-select the gift for the receiving user, and can also provide the conveying user with some recommendations. Depending on the options selected, the conveying user may or may not know what the gift is until it is redeemed by the receiving user.

In one implementation, the system enables the conveying user to convey to the receiving user a gift at relative proximity to an event or a specified time frame. For example, the conveying user may convey to the receiving user a drink or a dessert at a restaurant, a club, or any other venue. The gift may be conveyed based on visits or proximity to a venue or an event. The gifts may be queued up and delivered at specified or calculated intervals (e.g., beginning 3 days before the receiving user's birthday, or 30 minutes after the receiving user last purchased or received a gifted drink).

In one implementation, the conveying user may initiate such conveyances from a fixed location or from anywhere, including from a mobile device. These conveyances may be fulfilled using a fulfillment system that may be transparent to the receiving user, or may work with the receiving user for a convenient fulfillment time. The fulfillment system may also be transparent to the venue, using a centralized payment/credit service.

It will be apparent that the system provides an element of surprise, i.e., receiving a gift from someone who is not at the receiving user's location, but is now altering the receiving user's experience. For example, the system enables the conveying user to purchase a gift, such as a drink or a dessert, for the receiving user, who may be at a bar. The conveying user may make such a purchase from anywhere (including at home, at a bar, etc.), to anywhere the receiving user is located (such as the same bar, or another bar on the other side of the city, country, or world). The gift item may be conveyed for a special occasion such as a birthday or may be conveyed in a more casual manner.

The conveyance may be made in partnership with a venue (e.g., a restaurant, a bar, a club) to coordinate the delivery of the gifts, with the optional ‘surprise’ gift being delivered to the receiving user at a specified time (e.g., after the meal, or upon arrival). For example, a drink could be purchased and paid for using a payment system that works in conjunction with the fulfillment system. In one implementation, a participating venue may have a computer system linked via the Internet that receives instructions regarding fulfillment of the gift. For example, the venue (e.g., restaurant, bar) may receive a message on its computer instructing delivery of a dessert or a drink to a particular customer, i.e., the receiving user. The message may have detailed instructions regarding the gift item, the receiving user, and the date and time of delivery. The restaurant or bar may receive detailed instructions including scheduled delivery of one or more gifts to a plurality of customers (e.g., instructions to deliver the gifts over a certain period of time). The restaurant or bar may also receive the message via a mobile device. After the conveyance of the gift to the receiving user (customer), the cost of the gift may be charged to a credit card or may be deducted from an account.

In another example implementation, 5 people (i.e., conveying users) may order their friend (i.e., receiving user) a dessert for his birthday, to be fulfilled at a restaurant. Rather than having the receiving user receive all 5 gifts on his birthday, the gifts could be distributed appropriately each time the receiving user visits a venue on or near his birthday. The fulfillment system may automatically, or as specified by the conveying or the receiving user(s), start conveying the gifts X days before the birthday, and end after the receiving user has claimed all of the gifts. Therefore, the receiving user may receive 1 gift on each of 5 different trips to various venues, all within a certain proximity to the intended timeframe which in this case is within a week or two of one's birthday.

In one implementation, the fulfillment may be coordinated using multiple gifts. For instance, a drink may be conveyed by the fulfillment system upon arrival of the receiving user to the venue (e.g., a restaurant, a bar, or a club). The receiving user may then order an entree, and the fulfillment system may then convey a dessert after dinner. Thus, two gift items may be conveyed during a single trip to a venue.

In one implementation, the receiving user may be given the option of claiming the gift via a notification through his mobile phone or other device. For example, after 1 hour at the venue, the receiving user may receive a message on the mobile phone saying: “SURPRISE! Cindy has bought you a dessert! Would you like to accept?” Another message may, for example, say “Cindy has bought you a Friday's Cheesecake for dessert! ” Alternatively, a waiter at the venue linked with the system may bring the dessert out as a total surprise after the meal. Likewise, a drink, entree, appetizer, or mariachi band may be presented as a surprise during the meal.

In one example implementation, the receiving user may receive a gift of a credit of a specified amount. For example, the conveying user may send a gift of a general credit of $20 to the receiving user that may be redeemed at any participating venue. The receiving user may log onto the system and find all participating locations. Alternatively, the receiving user may be provided with a list of all participating venues, including participating venues that are located in a specific geographical area or within a certain distance or radius from the receiving user.

The gifts may be fulfilled at the receiving user's option at a convenient time, or the receiving user may be required to accept the gift at a specific time or within a certain time period, as required by the system, the venue, the conveying user, etc.

The conveyed gifts may or may not expire. A conveyed gift may have an expiration date/time, or the gift may be valid until the receiving user has made a certain number of trips to a restaurant/venue/location and still not claimed the gifts.

In one implementation, the system may allow various venues to bid on the fulfillment. Thus, for example, restaurants may bid for the chance to fulfill the gifts (e.g., drinks, desserts, etc.) to the receiving user. The winning bidder will get the chance to host the receiving user and to fulfill the conveyed gifts. For example, the conveying user may select a nice bar or a restaurant over a night club because the receiving user may prefer the bar or the restaurant. The venues or conveying users may also bid on what item or type/class of item may be conveyed (the precise gift may not be specified). The conveying user, the system, or affiliated venues may specify how long before/after the intended timeframe/event the gift is valid (or it may never expire).

In one implementation, the gift conveyance may be attempted and/or fulfilled a specified number of days prior to the intended timeframe or event (to allow for the unpredictable frequenting of venues by the receiving user). The system may also make suggestions based on the receiving user's habits of frequenting venues, and other information stored or calculated for the receiving user. It may also make suggestions based on information stored or calculated for a venue, class of venue, gift, gift type, time/date of/near intended fulfillment, etc.

In one implementation, the receiving user may be notified that he has a free gift (drink, entree, dessert, etc) waiting for him the next time he goes out, thereby encouraging the receiving user to go out. The venues may bid on order/type of presentation/fulfillment by their venue to the receiving user. The gift may include a surprise limousine ride to the venue or may include a coordinated “surprise” arrival/convergence of multiple friends.

In one implementation, the conveying user may set a variable price limit for the gift, such as up to $20. The receiving user may receive a message that says “Joe has bought you a drink!” The exact amount of the drink (or plus the system's commission) could be deducted from the conveying user's credit card or system account The gift may also be presented as a credit: “Joe has bought you a drink! (Gift value up to $10).” The receiving user may then use their card to pay. The fulfillment system may coordinate fulfillment with the venue and the venue would know the maximum value of the gift, and charge the receiving user extra if necessary.

In one implementation, the receiving user may be reimbursed later through the system. For example, the conveying user may pre-pay with his card, and that amount is later credited to the receiving user after fulfillment, which could make the system a centralized payment and/or fulfillment service. This would be useful for “anywhere” conveyance (for venues/locations that need not know about the system or that it is even being used. The system would take care of locating receiving users, updating their mobile devices and/or notifying them of gifts when they've reached a particular location capable of fulfillment of the gifts, and then the receiving user could pay as usual, and be reimbursed through our system with the funds provided by the conveying user. The system may charge the conveying user before or after the receiving user accepts the gift, reimburse the receiving user before or after via a credit to their account, etc.

In one implementation, a system enables the conveying user to select one or more gifts for the receiving user using a conveyance permission profile. The conveyance permission profile qualifies the conveyance of any gifts to the receiving user. The conveyance permission profile lists the receiving user's choices and preferences for one or more gifts, and also lists gifts that are not acceptable to the receiving user. These choices and preferences can be set up to vary based on who the conveying user is, and the relationship between the conveying user and the receiving user. A receiving user, for example, may permit a spouse or a friend to send a wide range of products and services, but may provide others only limited choices, e.g., allow others to send from only a few selected approved gifts. The conveyance permission profile is stored in a database or any other storage system.

The conveying user may identify the receiving user by the receiving user's electronic ID. The term “ID” or “electronic ID” and related words are used in their expansive sense to include any electronic data that may serve as an absolute unique mapping to a particular user or a group of users or a relative unique mapping that is unique within the subject reference pool. For example, account numbers, telephone numbers, email addresses, photos, avatars, icons, or any other representations of, or reference to, a user or a group of users may all be an ID or an electronic ID for understanding the embodiments and the present invention. Also, the term “receiving user” generally refers to the user receiving a gift while the term “conveying user” generally refers to the user generally sending the gift to the receiving user.

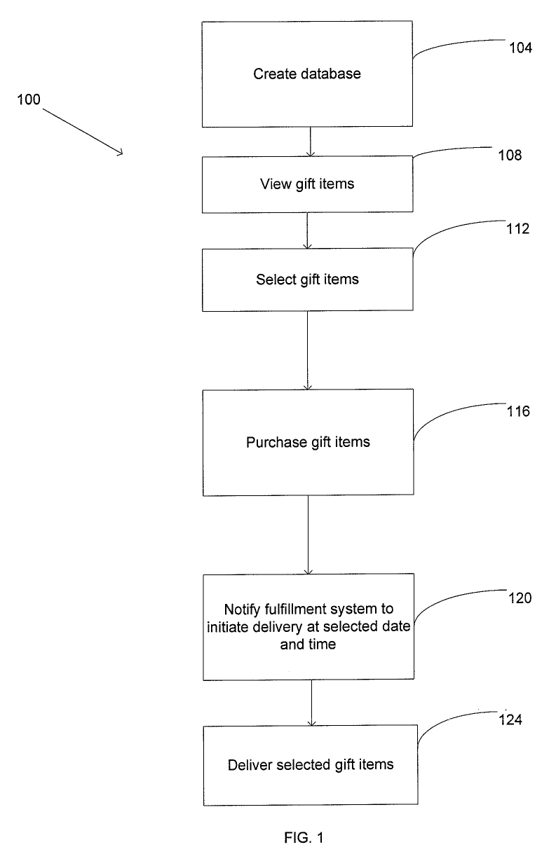

The features and elements of the embodiments described above may be implemented by the flow diagrams and systems described hereinafter. FIG. 1 is a flow diagram 100 of the method for conveying a gift item to the receiving user in accordance with one embodiment. In step 104, a database is created. The database includes identifying information of the receiving user such as an ID or any other reference to the receiving user. The database also includes the conveyance permission profile of the receiving user. In step 108, the conveying user views one or more gift items online. The gifts may be listed by the system by way of, for example, an online catalog or may be made available online in some other manner. In step 112, the conveying user selects one or more gifts from the list. In step 116, the conveying user purchases the selected gifts, by any of a variety of methods, such as by credit card, on account, or by a stored credit system. In step 120, the fulfillment system is notified to initiate delivery of the gifts at a selected date, time, and location. In step 124, the fulfillment system delivers the selected gifts to the receiving user at the selected date, time, and location.

It will be appreciated that the fulfillment (i.e., delivery of the gift) must be completed at an acceptable location or at a participating location. The delivery location must be accessible so that the gift may be delivered to the receiving user. Also, the venue where the gift is being delivered must be a participating venue or a venue that permits delivery of the gifts. In some instances, as will be explained, the venue such as a restaurant may be the fulfillment entity. In one implementation, the receiving user may be notified by a mobile device or otherwise to receive the gift at a certain location. For example, the receiving user may be notified to go to a specific restaurant to redeem a drink/dessert that is paid by the conveying user.

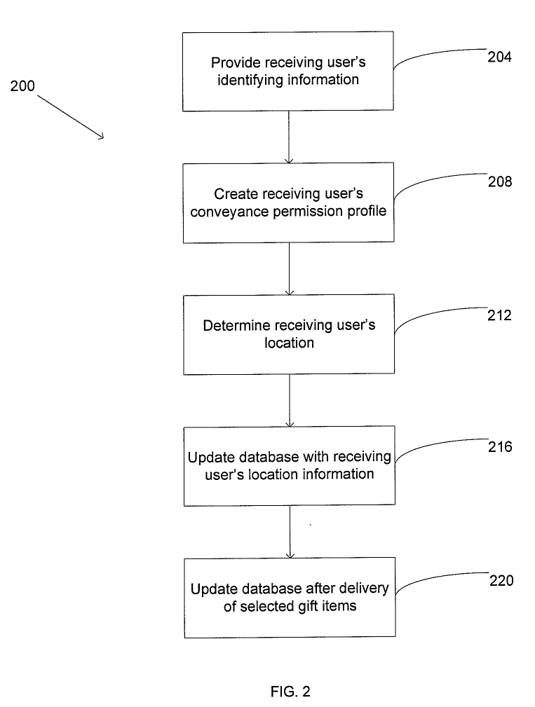

FIG. 2 is a flow diagram 200 of the method for creating the database in accordance with one embodiment. In step 204, the receiving user provides his identifying information. The identifying information may include an electronic ID or any other representation of the receiving user. The receiving user may also provide his contact information so that the system may contact the receiving user if necessary. In step 208, the receiving user creates his conveyance permission profile. As discussed before, the conveyance permission profile lists the receiving user's choices related to one or more gifts, or classes of gifts and qualifies gift items that can be sent to the receiving user. In step 212, the receiving user's location is determined by a location determination system. The location determination system may be one of several commercially available systems capable of tracking the receiving user's location.

In step 216, the database is optionally updated with the receiving user's location. In one implementation, the database receives periodic updates from the location determination system. In another implementation, the database is not updated with the receiving user's location information, but the location information is used to deliver the gift to the receiving user. In step 220, after one or more gift items have been conveyed to the receiving user, the database is updated to reflect the delivery of the gift items. For example, if the receiving user has received a particular type of gift, he may not want more of the same type of gifts. Thus, the conveyance permission profile may be updated to indicate that the particular gift item is no longer desired. If the receiving user is a member of an online social network, the receiving user's online profile may be updated to reflect that the receiving user has received one or more gifts.

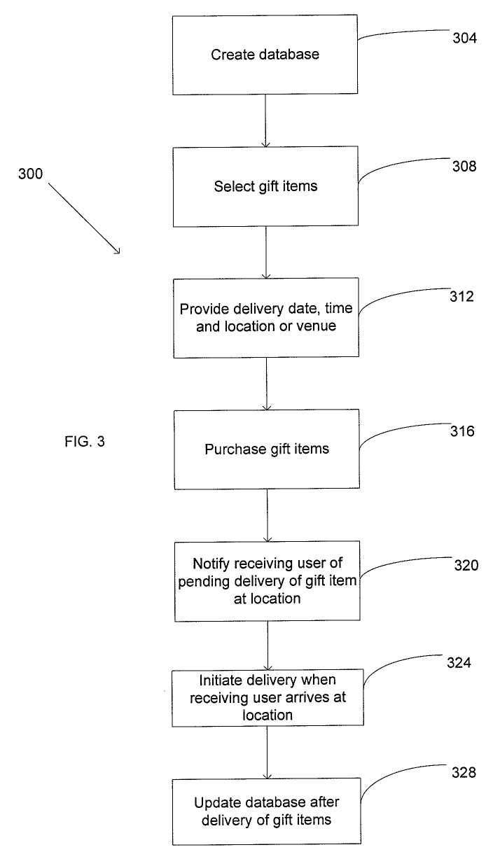

FIG. 3 is a flow diagram 300 of the method of conveying a gift item to the receiving user in accordance with another embodiment. In step 304, a database is created. As discussed before, the database includes the receiving user's identifying information and a conveyance permission profile. In step 308, the conveying user selects a gift from an online catalog of gifts. In step 312, the conveying user selects a delivery date, time, and location. For example, the conveying user may instruct that the gift is to be delivered to the receiving user on the receiving user's birthday. In step 316, the conveying user purchases the selected gift. The gift may be purchased online by a credit card, deduction from an account, or by other well-known methods. In step 320, the receiving user is notified of the pending delivery of the gift. The receiving user may, for example, be notified that a dessert or a drink will be delivered to him on his birthday at a specific restaurant or a type of restaurant or any participating venue that fulfills the gift. In step 324, the fulfillment system initiates delivery of the gift when the receiving user arrives at the designated venue. In step 328, after the gift is conveyed to the receiving user, the database is updated to reflect the fulfillment of the gift. In one implementation, the selected gift item is delivered to the receiving user without prior notice of the delivery to the receiving user.

In one example implementation, the method for conveying a gift as described above is implemented by an online social network. The online social network includes a group of users (e.g., thousands, or millions of users) each having some unique electronic identification by which users refer to one another. The conveying user may utilize the system to convey a gift to the receiving user, both the conveying user and the receiving user being members of the online social network.

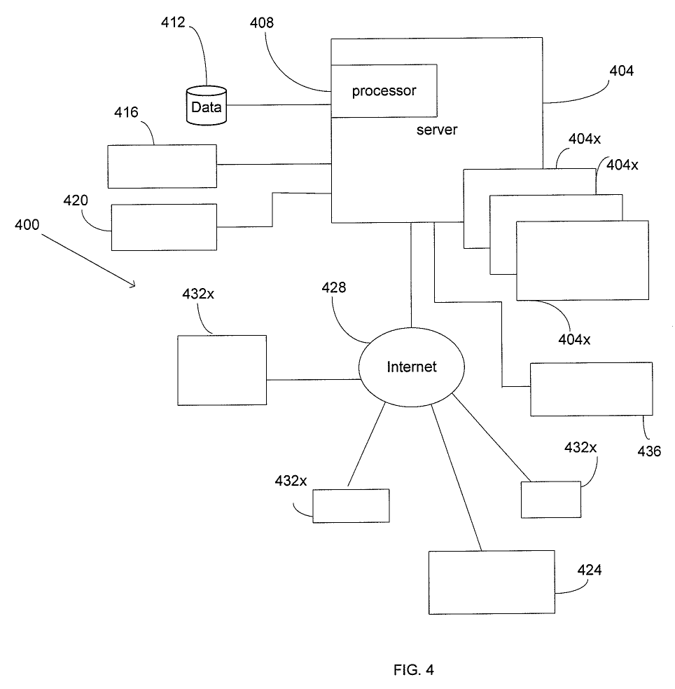

FIG. 4 is a system 400 that may be used to implement an example embodiment of the invention including at least portions of the disclosed embodiments. The system 400 includes a server 404 including a central processing unit 408. The server 404 includes one or more data structures for supporting message exchange among a set of client devices 432x. In one example implementation, any client device 432x successfully attaching to one of these data structures thereafter exchanges messages with one or more client devices attached to the same data structure. The server 404 serves one or more user interfaces 404x to enable the users to communicate with each other, access the database, view gift items, and conduct transactions. The client devices 432x may be a personal computer, a lap-top computer, a PDA, a mobile phone, a smart phone, or any other computing device. The conveying user may use one of the client devices 432x to convey the gift to the receiving user.

The server 404 is connected to a database 412 or any other data storage system. As discussed before, the database stores user identifying information, including ID and conveyance permission profile of the receiving user. The server 404 is connected to a gift selection application 416. The gift selection application 416 may be a software application or a routine configured to enable the conveying user to access a list of gifts online, to search one or more gifts based on the rules listed in the conveyance permission profile, and to select one or more gifts. As will be apparent to those skilled in the art, the gift selection application may be implemented in the server 404.

The system 400 includes a payment processing application 420. The payment processing application 420 may be a software application or a routine configured to enable the conveying user make a payment for any purchased gift. The payment processing application 420 may be implemented in the server 404. The payment processing application 420 may allow the conveying user to pay for the selected gift using a credit card or via a credit system implemented by an online social network or by any other well known methods.

The server 404 is connected to a fulfillment system 424 through a communication network such as the Internet 428. The fulfillment system 424 may be an online retailer that supports fulfillment of the gift. In appropriate circumstances, the venue (e.g., a restaurant, a club) may be the fulfillment system since the venue may be capable of fulfillment. For example, if the selected gift is a drink, or a dessert, the venue (e.g., restaurant) will act as the fulfillment system. It will understood by those skilled in the art that the fulfillment system 424 may be implemented in one or more methods. The fulfillment system may be used to deliver the gift item at predetermined time intervals and at selected dates chosen by the conveying user.

The server 404 supports a conveying process and is responsive to the conveying user to initiate conveyance of a gift. The receiving user may get a notification of the conveyance via one of the client devices 432x. Responsive to instructions from the server 404, the fulfillment system 424 initiates the delivery of the selected gift. For example, the gift item conveyed to the receiving user may be a drink, a dessert, a box of chocolates, flowers, a bottle of wine, a book, a gift certificate to a resort or a spa, a ticket to a concert, or a limousine ride.

In one implementation, a location determination system 436 provides the location information of the receiving user to the server 404. The location determination system 436 enables the system 400 to deliver the gift to the receiving user at the receiving user's current location. The location determination system 436 optionally updates the server 404 with the receiving user's location.

In one example implementation, a software application embodying a computer program code may be configured to select one or more gifts and deliver the gifts to the receiving user at selected dates and time. For example, the software application may initiate the delivery of a gift to the receiving user on his birthday. In other words, the software application may assume the role of the conveying user by selecting one or more gift items and initiating delivery of the gift items to the receiving user.

In one implementation, the system may enable certain receiving users (e.g., premium users) to receive pre-paid gifts at scheduled dates and times. Alternatively, the gifts may be delivered at dates, times or locations selected by the software application thus providing the element of surprise to the receiving user. The system may enable the receiving user to instruct delivery of various surprise gifts and may pre-pay via a credit card for the cost of the gift and delivery. Alternatively, the system may send the gift free or automatically as part of a premium service for certain users.

In one implementation, the steps of the methods described above may be executed by one or more computer readable codes embodied in a computer readable medium such as a computer program product. The computer program product may be a CD, a floppy disk, an optical disk, a hard drive or any other storage system.

The system, method, and computer program product described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines can operate in an operating system environment or as stand-alone routines occupying all, or a substantial part, of the system processing.

Embodiments of the invention may be implemented by using a general purpose digital computer, software applications, routines and software modules, hardware including application specific integrated circuits, programmable logic devices, field programmable gate arrays, optical and other mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

Reference throughout this specification to “one implementation”, “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the implementations or embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed is:

1. A software application for enabling a conveying user to select one or more gift items and to deliver the selected gift items to a receiving user at the receiving user's location, the software application residing in a server connected to a wide area network, the software application enabling the conveying user to select and deliver the gift items using a mobile wireless device, comprising:
a database implemented in the server, the database having identifying information for the receiving user, the database including a conveyance permission profile qualifying the conveyance of any gift items to the receiving user;
a gift selection application implemented in the server, the gift selection application enabling the conveying user to select one or more gift items from an online gift catalog, the selected gift items not being prohibited by the conveyance permission profile, the gift selection application enabling the conveying user to specify a date and time for the delivery of the selected gift item to the receiving user;
a payment processing application implemented in the server, the payment processing application enabling the conveying user to purchase the selected gift; and
a fulfillment system connected to the wide area network, the fulfillment system responsive to an instruction from the gift selection application delivering the selected gift item to the receiving user at the selected date and time at the receiving user's location.

2. The software application according to claim 1, wherein the server is implemented in an online social network, and wherein the conveying user and the receiving user are members of the online social network.

3. The software application according to claim 1, wherein the wide area network is the Internet.

4. The software application according to claim 1, wherein the conveyance permission profile includes a list of categories of products and services acceptable to the receiving user and includes a list of prohibited products and services.

5. The software application according to claim 1, wherein the selected gift item is delivered to the receiving user without prior notice of the delivery to the receiving user.

6. The software application according to claim 1, further comprising a location determination system configured to locate the receiving user's physical location.

7. The software application according to claim 1, wherein the fulfillment system delivers to the receiving user each of the selected gift items at predetermined time intervals chosen by the conveying user.

8. The software application according to claim 1, wherein the payment processing application enables the conveying user to purchase the selected gift item online.

9. A social networking system having a plurality of users, the system enabling a conveying user to deliver a gift item to a receiving user at the receiving user's location, comprising:
a database having identifying information for the receiving user, the database including a conveyance permission profile qualifying the conveyance of any gift item to the receiving user;
a gift selection system listing a plurality of gift items, the gift selection system enabling the conveying user to select one or more gift items, the selected gift items not being prohibited by the conveyance permission profile, the gift selection system enabling the conveying user to specify a date and time for the delivery of the selected gift item;
a payment processing system enabling the conveying user to purchase the selected gift;
a fulfillment system configured to deliver the selected gift item to the receiving user at the selected time at the receiving user's location; and
a communication system enabling communication among the conveying user, the database, the gift selection system, the payment processing system, and the gift fulfillment system.

10. The system according to claim 9, further comprising a software application for enabling the conveying user to access the system to select and convey one or more gift items to the receiving user from a mobile wireless device.

11. The system according to claim 9, wherein the selected gift item is delivered to the receiving user without prior notice of the delivery to the receiving user.

12. The system according to claim 9, further comprising a location determination system configured to locate the receiving user's physical location, the location determination system updating the database with the receiving user's location.

13. The system according to claim 9, wherein the database is implemented in an online social network, and wherein the conveying user and the receiving user are members of an online social network.

14. The system according to claim 13, further comprising posting a notification on the online social network site of the fulfillment of the selected gift items.

15. The system according to claim 9, wherein the conveying user is a computer program code configured to select one or more gifts and initiate delivery of the gifts to the receiving user.

16. A method for enabling a conveying user to select one or more gift items and to deliver the selected gift items to a receiving user at the receiving user's location at a selected date and time, the conveying user and the receiving user being connected through a communication network, comprising:
creating a database having identifying information and a conveyance permission profile for the receiving user, the conveyance permission profile qualifying the conveyance of any gift items to the receiving user;
determining the location of the receiving user, the location being provided by a location determination system;
receiving, by the database, the location of the receiving user;
selecting, by the conveying user, one or more gift items from an online gift catalog, the selected gift items not being prohibited by the conveyance permission profile;
selecting, by the conveying user, a delivery date and time of the selected gift items;
purchasing, by the conveying user, the selected gift items;
notifying a fulfillment system of the selection of the gift items; and
commencing delivery of the selected gift items in response to the notification, the selected gift items being delivered to the receiving user at the location at the selected date and time.

17. The method according to claim 16, further comprising notifying the receiving user prior to the delivery of the gift.

18. The method according to claim 16, further comprising purchasing the selected gift items by a credit card.

19. The method according to claim 16, wherein the conveying user is a computer program code configured to select one or more gifts and initiate delivery of the gifts to the receiving user at a selected date, time and location.

20. The method according to claim 16, wherein the conveyance permissions profile limits conveyances of gift items to the receiving user.

21. A method for enabling a conveying user to select one or more gift items and to deliver the selected gift items to a receiving user at selected premises at a selected date and time, the conveying user and the receiving user being members of an online social network, the conveying user and the receiving user being connected by a communication network, comprising:
creating a database having identifying information and a conveyance permission profile for the receiving user, the conveyance permission profile qualifying the conveyance of any gift items to the receiving user;
selecting, by the conveying user, one or more gift items from an online gift catalog, the selected gift items not being prohibited by the conveyance permission profile;
selecting, by the conveying user, the premises and a delivery date and time of the selected gift items;
purchasing, by the conveying user, the selected gift items;
notifying the selected premises of the pending fulfillment of the selected gift items to the receiving user at the selected date and time;
acknowledging, by the selected premises, the receipt of the notification for the pending fulfillment of the selected gift items to the receiving user at the selected date and time;
notifying the receiving user of the pending delivery of the selected gift items at the selected premises, the receiving user being prompted to visit the selected premises to receive the selected gift items; and
commencing delivery of the selected gift items to the receiving user when the receiving user arrives at the selected premises.

22. The method according to claim 21, further comprising notifying the conveying user of the successful delivery of the selected gift items to the receiving user.

23. The method according to claim 21, further comprising posting a notification on the online social network site of the fulfillment of the selected gift items.

24. The method according to claim 21, wherein the conveying user selects the gift items and initiates the fulfillment of the gift items from a mobile wireless device.

25. A computer program product having computer-readable instructions embodied on a computer-readable medium implementing a method for initiating a delivery of a gift by a conveying user to a receiving user, the conveying user and the receiving user being members of an online social network, the method comprising:
creating a database having identifying information and a conveyance permission profile for the receiving user, the conveyance permission profile qualifying the conveyance of any gift items to the receiving user;
determining the location of the receiving user, the location being provided by a location determination system;
receiving, by the database, the location of the receiving user;
selecting, by the conveying user, one or more gift items from an online gift catalog, the selected gift items not being prohibited by the conveyance permission profile;
selecting, by the conveying user, a delivery date and time of the selected gift items;
purchasing, by the conveying user, the selected gift items;
notifying a fulfillment system of the selection of the gift items; and
commencing delivery of the selected gift items in response to the notification, the selected gift items being delivered to the receiving user at the location at the selected date and time.
